(19) United States
(12) Patent Application Publication
(10) Pub. No.: US 2021/0288798 A1
(43) Pub. Date: Sep. 16, 2021

(54) JIGSAW KEY ENCRYPTION/DECRYPTION

(71) Applicant: International Business Machines Corporation, Armonk, NY (US)

(72) Inventors: Saarthak Vadhera, Ghaziabad (IN); Rinkesh I. Bansal, Pune (IN); Chintan Thaker, Pune (IN); Sanjay B. Panchal, Mumbai (IN); Vinod A. Valecha, Pune (IN)

(21) Appl. No.: 16/819,769

(22) Filed: Mar. 16, 2020

(51) Int. Cl. H04L 9/08; H04L 29/06

(52) U.S. Cl. CPC H04L 9/0869; H04L 63/0442; H04L 63/0435

(57) ABSTRACT

A computer-implemented method for generating a symmetric key for data encryption includes receiving a first request from an entity to generate a first symmetric key for data encryption. The computer-implemented method further includes retrieving a first secret data element and a second secret data element from one or more secret data servers. The computer-implemented method further includes dividing each of the first secret data element and the second secret data element into a number of secret data element byte strings. The computer-implemented method further includes generating the first symmetric key for data encryption based, at least in part, on combining a first secret data element byte string from the first secret data element and a second secret data element byte string from the second secret data element.

### BACKGROUND

The present invention relates generally to the field of key management, and more particularly to key encryption.

Key management is the process of managing the lifecycle of cryptographic keys in a cryptosystem. This includes the generation, creation, protection, storage, exchange, use, destruction (i.e., crypto-shredding), and replacement of keys. In addition to access restriction, key management also involves the monitoring and recording of each key's access, use, and context.

An encryption key is typically a random string of bits generated specifically to scramble and unscramble data. Encryption keys are created with algorithms designed to ensure that each key is unique and unpredictable. The longer the key, the harder it is to crack the encryption code. Currently, the Advanced Encryption Standard (AES), and more particularly, 256-bit AES, is the encryption standard recognized and recommended by the United States government.

### SUMMARY

According to one embodiment of the present invention, a computer-implemented method for generating symmetric keys for encrypting data includes receiving a first request from an entity to generate a first symmetric key for encrypting data. The computer-implemented method further includes retrieving a first secret data element and a second secret data element from one or more secret data servers. The computer-implemented method further includes dividing each of the first secret data element and the second secret data element into a number of secret data element byte strings. The computer-implemented method further includes generating the first symmetric key for data encryption based, at least in part, on combining a first secret data element byte string from the first secret data element and a second secret data element byte string from the second secret data element.

According to another embodiment of the present invention, a computer-implemented method for regenerating symmetric keys for decrypting data includes receiving, by a server-side device, a request for a plurality of secret data elements for regenerating a symmetric key for access to encrypted data. The computer-implemented method further includes retrieving, by the server-side device, a first secret data element and a second secret data element from a first secret data server. The computer-implemented method further includes transmitting, by the server-side device, the first secret data element and the second secret data element to the client-side device. The computer-implemented method further includes regenerating, by the client-side device, the symmetric key based on a decryption policy. The decryption policy includes: a first rule for dividing each of the first secret data element and the secret data element into a number of secret data element byte strings, a second rule for selecting a first secret data element byte string from the first secret data element and a second secret data element byte string from the second secret data element, and a third rule for combining the first secret data element byte string and the second secret data element byte string to form the symmetric key.

According to another embodiment of the present invention, a computer-implemented method for regenerating symmetric keys for decrypting data includes receiving, by a server-side device, a request from a client-side device for a symmetric key to access encrypted data. The computer-implemented method further includes retrieving, by the server-side device, a first secret data element and a second secret data element from a first secret data server. The computer-implemented method further includes regenerating, by the server-side device, the symmetric key based on a decryption policy. The decryption policy includes a first rule for dividing each of the first secret data element and the secret data element into a number of secret data element byte strings, a second rule for selecting a first secret data element byte string from the first secret data element and a second secret data element byte string from the second secret data element, and a third rule for combining the first secret data element byte string and the second secret data element byte string to form the symmetric key. The computer-implemented method further includes transmitting, by the server-side device, the symmetric key to the client-side device.

### BRIEF DESCRIPTION OF THE DRAWINGS

FIG. 1 is a functional block diagram of a computing environment, generally designated 100, suitable for operation of a symmetric key program 101 in accordance with at least one embodiment of the present invention.

FIG. 2 is a flow chart diagram depicting operational steps for generating a symmetric key for data encryption for the first time in accordance with at least one embodiment of the present invention.

FIG. 3 is a flow chart diagram depicting operational steps for regenerating, on a server side device, a symmetric key for decrypting data in accordance with at least one embodiment of the present invention.

FIG. 4 is a flow chart diagram depicting operational steps for regenerating, on a client-side device, a symmetric key for decrypting data in accordance with at least one embodiment of the present invention.

FIG. 5A is a block diagram that illustrates generating a first symmetric key from a set of secret data elements in accordance with at least one embodiment of the present invention.

FIG. 5B is a block diagram that illustrates generating a second symmetric key from the same set of secret data elements of FIG. 5A in accordance with at least one embodiment of the present invention.

FIG. 6 is a block diagram depicting components of a computing device, generally designated 600, suitable for executing the computing devices depicted in FIG. 1 in accordance with at least one embodiment of the present invention.

### DETAILED DESCRIPTION

There exists two types of encryption algorithms: symmetric algorithms and asymmetric algorithms. Symmetric, or secret key encryption, uses a single key for both encryption and decryption. Typically, symmetric key encryption is used for encrypting large amounts of data efficiently. An example of a symmetric key is a 256-bit AES key. Asymmetric, or public/private key encryption, uses a pair of keys. Data encrypted by one key can only be decrypted by the other key in a public/private key pair. Generally, when an asymmetric key pair is generated, the public key is used to encrypt data, and the private key is used to decrypt the data.

When considering whether to use symmetric vs. asymmetric encryption, each form of encryption carries certain advantages and disadvantages. For example, symmetric key encryption is generally faster than asymmetric key encryption since symmetric key encryption doesn't require as many central processing unit (CPU) cycles as asymmetric key encryption. However, with symmetric key encryption, the security of symmetric keys themselves is the biggest challenge. Symmetric keys are generally stored on key encryption servers. If a key encryption server is compromised and a symmetric encryption key is obtained, the same key used to encrypt data can be used to decrypt any data encrypted by that key. Similarly, since the same key is used to encrypt and decrypt information, the same key used to encrypt data must be shared or distributed for a user to decrypt the data. If a malicious actor intercepts the key, they are able to access the encrypted information. This issue of key distribution becomes even more pronounced in a file transfer environment, which can involve the distribution of the same symmetric key between a large number of users.

A current approach for securing data over a computer network is cryptographic splitting (i.e., cryptographic bit splitting, cryptographic data splitting, encryption key splitting, split key encryption). Under this approach, a single encrypted key is generated, the encrypted key is split into smaller data units (or chunks), and the smaller data units are distributed to different storage locations. Under this approach, each data unit on its own, if decrypted, is useless unless recombined with all decrypted data units dispersed among the different storage locations. Accordingly, cryptographic splitting provides for increased data protection against security breaches.

Embodiments of the present invention provide for generating a symmetric encryption key from secret data stored on a plurality of secret data servers. This is particularly advantageous in that an individual secret data server does not store all of the secret data elements necessary to regenerate the symmetric key for data decryption. Accordingly, even if one of the secret data servers is hacked, the symmetric key cannot be created based solely on the secret data contained on a single server. Moreover, embodiments of the present invention provide for dividing secret data stored on a plurality of secret data servers into a plurality of byte strings and selecting particular byte strings to form a symmetric key based on a policy or set of rules. This is particularly advantageous in that even if all of the secret data servers are hacked, the logic for recreating the symmetric key would still be required. In other words, even if a hacker obtained access to every piece of secret data included in all of the secret data servers, the hacker would not know which particular secret data to select, how each secret data should be divided, which divided portions to select, and how to combine the particular divided portions to ultimately regenerate the symmetric key.

In various embodiments of the present invention, a 256-bit AES key (or higher) is generated from secret data retrieved from one or more secret data servers. In an embodiment, a respective secret data element is selected from each of a plurality of secret data servers. The respective secret data elements are divided into a plurality of secret data element byte strings. A byte string is selected from each of the plurality of secret data elements and combined to form a new 256-bit AES key. In an embodiment, a respective secret data element is selected from each of a plurality of secret data servers. A secret data element selected from one of the plurality of secret data servers is used to form a new 256-bit AES key. In an embodiment, a respective secret data element is selected from each of a plurality of secret data servers. A particular byte string is selected from each of the secret data elements based on a policy or set of rules. Each particular byte string selected is combined to form a new 256-bit AES key. In an embodiment, a respective secret data element is selected from each of a plurality of secret data servers. The respective secret data elements are translated or encrypted into another form, or code, such that the secret data elements are indecipherable. A particular byte string is selected from each of the encrypted secret data elements based on a policy or set of rules. Each particular byte string selected from the encrypted secret data elements is combined to form a new 256-bit AES key.

In some embodiments, all of the processing necessary to generate a symmetric key is performed on a server-side device. For example, in response to receiving a request for a key from an entity, such as a user, application, client device, or service, a server-side device performs the following operations: (i) selects respective secret data elements from each of a plurality of secret data servers; (ii) divides each respective secret data element into a plurality of secret data element byte strings; (iii) selects and combines respective secret data element byte strings to form a 256-bit AES key; and returns the 256-bit AES key to the requesting entity. Here, the division, selection, and combination of respective secret data elements to form a 256-bit AES key is performed in accordance with a decryption policy accessible by symmetric key program 101.

In some embodiments, a server-side device performs only a portion of the processing necessary to generate a symmetric key. For example, in response to receiving a request for a key from a client device, a server-side device identifies a set of secret data elements associated with the client device and returns the set of secret data elements to the client device. The client device then performs the following operations based on an encryption policy: (i) divides each respective secret data element into a plurality of secret data element byte strings; and (ii) selects and combines respective secret data element byte strings to form a new, 256-bit AES key. Here, the division, selection, and combination of respective secret data elements to form a 256-bit AES key is in accordance with a decryption policy only accessible by the client device requesting the secret data elements.

In various embodiments of the present invention, a unique decryption policy for regenerating a symmetric key is automatically created each time a symmetric key is initially generated. A decryption policy as used herein shall generally be understood as a set of rules or logic used to regenerate a particular symmetric key for data decryption. In an embodiment, a decryption policy includes one or more of the following: (i) the logic for dividing or splitting respective secret data elements into a plurality of byte strings; (ii) the logic for selecting particular byte strings from respective secret data elements; and (iii) the logic for combining the particular byte strings in a particular order to form a 256-bit AES key.

One of ordinary skill in the art will appreciate that through the use of a decryption policy in accordance with embodiments of the present invention, symmetric keys need not be shared or otherwise transmitted between parties. This is particularly advantageous in that the potential for a symmetric key being sent to the wrong party or intercepted by a malicious actor is eliminated. Similarly, it should be appreciated that through the use of a decryption policy in accordance with embodiments of the present invention, symmetric keys need not ever be stored, thereby remaining compliant as per market regulations such as General Data Protection Regulation (GDPR) and Health Insurance Portability and Accountability Act (HIPPA).

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

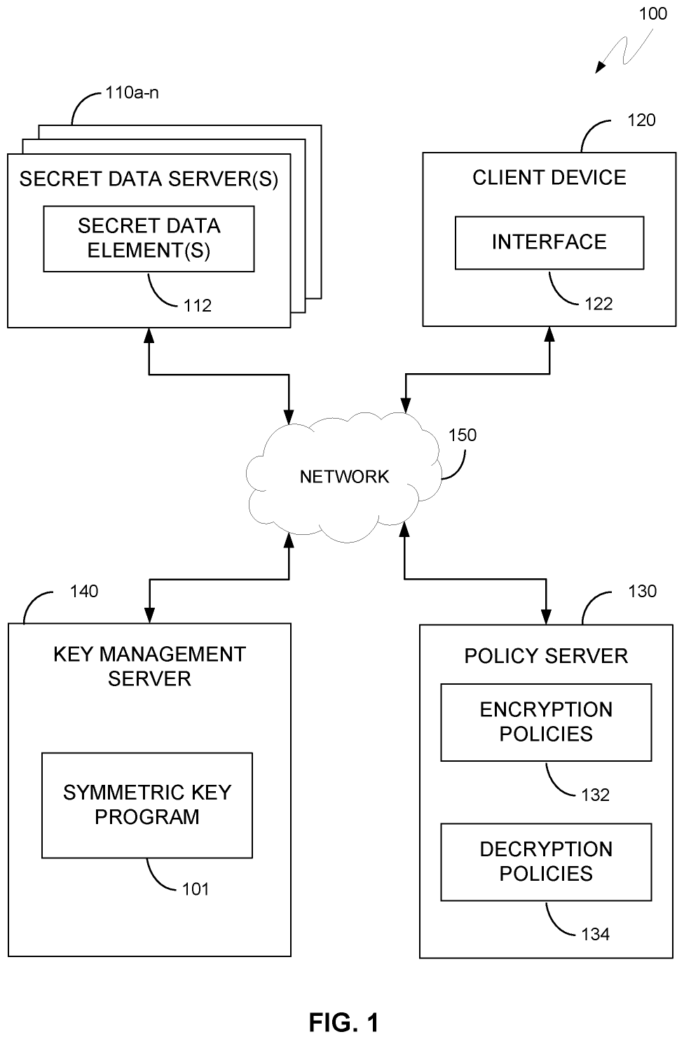

The present invention will now be described in detail with reference to the Figures. FIG. 1 is a functional block diagram illustrating a computing environment, generally designated 100, in accordance with at least one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 includes secret data server(s) 110a-n, client device 120, policy server 130, and key management server 140 interconnected over network 150. In embodiments of the present invention, network 150 can be a telecommunications network, a local area network (LAN), a wide area network (WAN), such as the Internet, or a combination of the three, and can include wired, wireless, or fiber optic connections. Network 150 may include one or more wired and/or wireless networks that are capable of receiving and transmitting data, voice, and/or video signals, including multimedia signals that include voice, data, and video information. In general, network 150 may be any combination of connections and protocols that will support communications between secret data server(s) 110a-n, client device 120, policy server 130, key management server 140, including symmetric key program 101, and other computing devices (not shown) within computing environment 100.

In various embodiments of the present invention, each of secret data server(s) 110a-n, client device 120, policy server 130, and key management server 140 is a computing device that can be a standalone device, a management server, a web server, a mobile device, or any other electronic device or computing system capable of receiving, sending, and processing data. In an embodiment, each of secret data server(s) 110a-n, client device 120, policy server 130, and key management server 140 represents a server computing system utilizing multiple computers as a server system, such as in a cloud computing environment. In an embodiment, each of secret data server(s) 110a-n, client device 120, policy server 130, and key management server 140 represents a computing system utilizing clustered computers and components (e.g. database server computers, application server computers, web server computers, etc.) that act as a single pool of seamless resources when accessed within network computing environment 100. In general, each of secret data server(s) 110a-n, client device 120, policy server 130, and key management server 140 represents any programmable electronic device or combination of programmable electronic devices capable of executing machine readable program instructions and communicating with each other, including symmetric key program 101 and other computing devices (not shown) within computing environment 100 via a network, such as network 150.

Secret data server(s) 110a-n stores secret data element(s) 112 that is utilized to generate symmetric keys for data encryption/decryption in accordance with various embodiments of the present invention. Secret data, as used herein, shall refer to any type of data (e.g., random data strings, key management interoperability protocol (KMIP)/vault secrets, secret keys, API keys, passwords, tokens, or any general information) that is securely stored, and access thereto, regulated. For example, secret data may be any type of data that requires logical security, such as passwords, data encryption, authentication, and authorization.

Client device 120 allows a user, application, system, or service to request symmetric keys for encryption/decryption of information. Client device 120 may be a laptop computer, tablet computer, netbook computer, personal computer (PC), a desktop computer, a personal digital assistant (PDA), a smart phone, or any programmable electronic device capable of receiving, sending, and processing data. In general, client device 120 represents any programmable electronic device or combination of programmable electronic devices capable of executing machine readable program instructions and communicating with symmetric key program 101, secret data servers 110a-n, policy server 130, key management server 140, and other computing devices (not shown) within computing environment 100 via a network, such as network 150.

Client device 120 includes interface 122. Interface 122 provides an interface between symmetric key program 101, secret data servers 110a-n, policy server 130, key management server 140, and other computing devices (not shown). Interface 122 may be a graphical user interface (GUI) or a web user interface (WUI) and can display text, documents, web browser windows, user options, application interfaces, and instructions for operation, and includes the information (such as graphic, text, and sound) that a program presents to a user and the control sequences the user employs to control the program.

Policy server 130 stores encryption policies 132 and decryption policies 134 that are utilized by symmetric key program 101 to generate symmetric keys for data encryption/decryption in accordance with various embodiments of the present invention. An encryption policy, as used herein, shall generally refer to a set of rules or logic for generating a symmetric key from secret data for data encryption. In some embodiments, encryption policies 132 include the logic by which symmetric key program 101 selects particular authorized secret data server(s) 110a-n for retrieval of secret data to generate a symmetric key. In an embodiment, an encryption policy includes a rule that defines a number of secret data server(s) 110a-n that must be selected. For example, an encryption policy includes a rule that the number of secret data server(s) 110a-n selected must exceed a predetermined threshold (e.g., at least 5 secret data server(s) 110a-n from which a requesting entity is authorized to access must be selected). In an embodiment, an encryption policy includes a rule for selecting particular secret data server(s) 110a-n based on the particular data being encrypted. For example, an encryption policy associated with User A includes a first rule that secret data can only be retrieved from SecretDataServer_110d and SecretDataServer_110f when generating a symmetric key for data encryption of Datafile_9. Similarly, the encryption policy associated with User A includes a second rule that secret data can only be retrieved from SecretDataServer_110a and SecretDataServer_110d when generating a symmetric key for data encryption of Datafile_11. In an embodiment, an encryption policy includes the particular secret data server(s) 110a-n authorized for retrieval of secret data for generating a symmetric key for data encryption for a particular entity. For example, an encryption policy associated with Enterprise_1 includes a rule that secret data can only be retrieved from SecretDataServer_110a and SecretDataServer_f when generating a symmetric key for data encryption of data accessible by Enterprise_2.

In some embodiments, encryption policies 132 include the logic by which symmetric key program 101 retrieves or otherwise accesses particular secret data elements 112 stored on secret data server(s) 110a-n to generate a symmetric key. In an embodiment, a secret data selection policy includes a rule that at least one secret data element 112 must be selected from a minimum number of authorized secret data server(s) 110a-n for generating a symmetric key for data encryption. In an embodiment, an encryption policy includes a rule that defines the particular secret data element(s) to be retrieved from particular secret data servers 110a-n. For example, an encryption policy associated with User C includes a rule that the following secret data elements should be used to generate symmetric keys for data encryption: Token_3 stored on SecretDataServer_110a, Social Security Number_9 stored on SecretDataServer_110d, and API Key_17 stored on SecretDataServer_110f. In an embodiment, an encryption policy includes a rule that defines the particular secret data elements 112 to be retrieved from particular secret data servers 110a-n based on the particular data being encrypted. For example, an encryption policy associated with User A includes a rule that the following secret data elements should be used when generating a symmetric key for data encryption of Datafile_9: Token_7 stored on SecretDataServer_110a, Credit Card Number_3 stored on SecretDataServer_110d, and Password_7 stored on SecretDataServer_110f. In an embodiment, an encryption policy includes a rule that defines the particular secret data elements 112 to be retrieved from particular secret data server(s) 110a-n based on a particular entity having access to the data being encrypted. For example, an encryption policy associated with Enterprise_1 includes a rule that the following secret data elements should be retrieved when generating a symmetric key for data encryption of any data that Enterprise_2 has access to: Token_9 stored on SecretDataServer_110a, API Key 7 stored on SecretDataServer_110d, and Password 5 stored on SecretDataServer_110g.

In some embodiments, encryption policies 132 include the logic by which symmetric key program 101 divides or splits selected secret data elements 112 into various byte strings. In an embodiment, an encryption policy includes a rule for dividing a secret data element into a predetermined number of byte strings of fixed size (e.g., an 128-bit secrete data element should be divided into sixteen 1-byte strings, eight 2-byte strings, four 4-byte strings, etc.).

In some embodiments, encryption policies 132 include the logic by which symmetric key program 101 selects and combines particular byte strings of respective secret data elements 112 to form a symmetric key for data encryption. For example, an encryption policy may include a rule that a symmetric key must include at least one byte string randomly selected from each of the secret data elements 112 selected for use in generating the symmetric key. In another example, an encryption policy may include a rule that defines the particular order in which partial secret data element byte strings are combined.

A decryption policy, as used herein, shall generally refer to a set of rules or logic for regenerating a symmetric key from secret data elements 112 for data decryption. In various embodiments of the present invention, a unique decryption policy for regenerating a symmetric key is automatically created each time a symmetric key is initially generated. Decryption policies 134 include, but are not limited to, one or more of the following: (i) the logic for dividing or splitting respective secret data elements 112 into a plurality of byte strings; (ii) the logic for selecting particular byte strings from respective secret data elements 112; and (iii) the logic for combining the particular selected byte strings in a particular order to form a 256-bit AES key. It should be appreciated that the logic included in a decryption policy used to regenerate a symmetric key for data decryption should mirror the logic used to initially generate the symmetric key for data encryption.

Key management server 140 includes symmetric key program 101. In various embodiments of the present invention, symmetric key program 101 generates symmetric keys (i.e., symmetric cryptographic keys) from secret data elements 112 stored on secret data servers 110a-n. One of ordinary skill in the art will appreciate that in the field of cryptography, a symmetric key is a key that is used both to encrypt plaintext and decrypt ciphertext. In some embodiments, symmetric key program 101 retrieves secret data elements from a single secret data server(s) 110a-n for use in generating a symmetric key. In other embodiments, symmetric key program 101 retrieves secret data elements from a plurality of secret data servers 110a-n for use in generating a symmetric key.

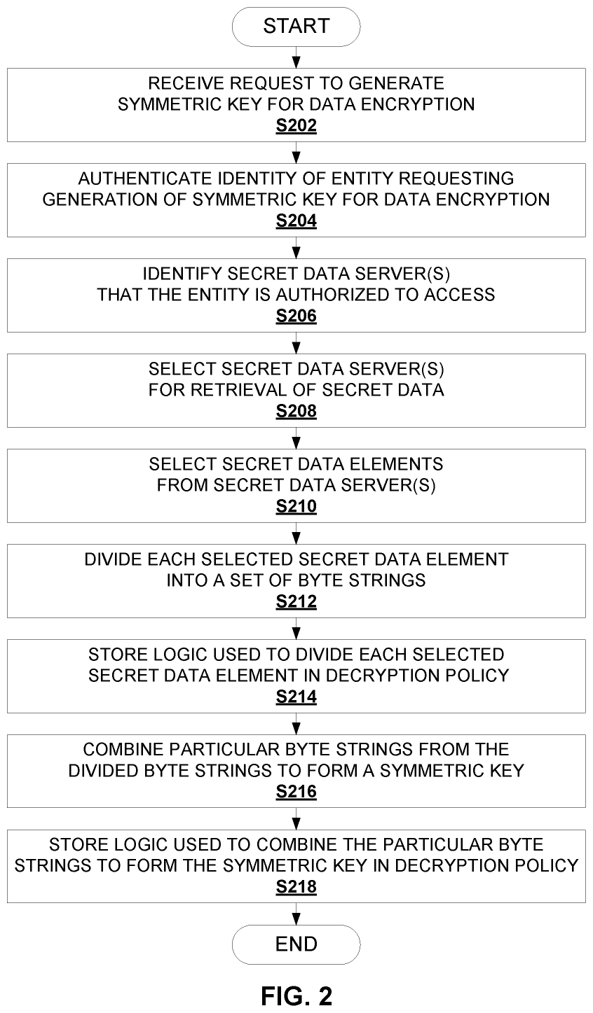

FIG. 2 is a flow chart diagram depicting operational steps for generating a symmetric key for the first time for data encryption in accordance with at least one embodiment of the present invention. FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

At step S202, symmetric key program 101 receives a request from client device 120 to generate a symmetric key for data encryption. In an embodiment, the request is generated by a user. In an embodiment, the request is generated by a device. In an embodiment, the request is generated by an application. In an embodiment the request is generated by a service.

At step S204, symmetric key program 101 authenticates an identity of the entity associated with the request to generate the symmetric key for data encryption. For example, symmetric key program 101 authenticates a user identity based on the user providing a successful username and password combination. In another example, symmetric key program 101 authenticates an application based on the application providing a unique client ID and secret (the client ID and secret being used as the username and password) registered for the application. In yet another example, symmetric key program 101 authenticates a device based on the device providing a unique device ID and secret (the device ID and secret being used as the username and password) registered for the device.

At step S206, responsive to successfully authenticating the identity of an entity associated with the request to generate the symmetric key for data encryption, symmetric key program 101 identifies one or more secret data servers 110a-n that the entity is authorized to access. In an embodiment, symmetric key program 101 identifies one or more secret data servers 110a-n that the entity is authorized to access based on comparing an identity of the entity (e.g., user ID, client ID, device ID) to a set of permissions included in a secret data server access control list (ACL). One of ordinary skill in the art will appreciate that an ACL is a list of permissions attached to a device and/or data object. An ACL specifies which entities are granted access to a device and/or data object(s) stored thereon. In an embodiment, symmetric key program 101 identifies one or more secret data servers 110a-n that the entity is authorized to access based on comparing a designated role of the entity (e.g., superuser administrator, general user, privileged user, customer) to permissions assigned to the particular role within an enterprise.

At step S208, symmetric key program 101 selects one or more secret data servers 110a-n for retrieval of secret data elements 112. It should be appreciated that symmetric key program 101 only selects secret data servers 110a-n for retrieval of secret data elements 112 that the requesting entity is authorized to access.

In some embodiments, the logic by which symmetric key program 101 selects a particular secret data servers 110a-n for retrieval of secret data elements 112 is random each time a request for generation of a symmetric key for data encryption is received. For example, symmetric key program 101 receives a request from User A to generate a symmetric key to encrypt Datafile_123. In this example, User A is authorized to access secret data elements 112 stored on SecretDataServer_110a, SecretDataServer_110d, and SecretDataServer_110f. Thus, symmetric program 101 may randomly select one of these three secret data servers, all three of these secret data servers, or any possible combination thereof. Although the previous example includes three secret data servers, one of ordinary skill in the art will appreciate that in various embodiments of the present invention, symmetric key program 101 can randomly select any number of authorized secret data servers 110a-n for retrieval of secret data.

In some embodiments, the logic by which symmetric key program 101 selects particular secret data servers 110a-n is based on an encryption policy 132 associated with the requesting entity. In some embodiments, the logic by which symmetric key program 101 selects particular secret data servers 110a-n is included or indicated in the request. For example, User B is authorized to access SecretDataServer_110a, SecretDataServer_110c, SecretDataServer_110e, and SecretDataServer_110g. In the request generated by User B for generation of a symmetric key for data encryption, User B can select or indicate which of the previously mentioned secret data servers symmetric key program 101 should retrieve secret data elements 112 from for generation of a symmetric key for data encryption. On the other hand, if User B makes no indication as to particular secret data servers 110a-n, symmetric key program 101 automatically randomly selects one or more secret data servers 110a-n for retrieval of secret data elements 112 for generation of a symmetric key for data encryption.

At step 210, symmetric key program 101 selects one or more secret data elements 112 from secret data servers 110a-n selected in step S208. It should be appreciated that symmetric key program 101 only retrieves secret data elements 112 that an entity is authorized to access. In some embodiments, the logic by which symmetric key program 101 retrieves particular secret data elements 112 stored on selected secret data servers 110a-n is random. In other words, the type(s) of secret data and the number of individual secret data elements retrieved is random each time a request for generation of a symmetric key for data encryption is received. For example, symmetric key program 101 receives a request from Application “C” to generate a symmetric key to encrypt Datafile_123. In this example, Application “C” is authorized to access SecretDataServer_110a, SecretDataServer_110d, and SecretDataServer_110f. Thus, symmetric key program 101 may randomly select to retrieve at least one secret data element 112 from only one of these three secret data servers, all three secret data servers, or any possible combination thereof. Although the previous example includes three secret data servers 110a-n, one of ordinary skill in the art will appreciate that in various embodiments of the present invention, symmetric key program 101 can randomly retrieve secret data elements 112 from any number of authorized secret data servers 110a-n for retrieval of secret data elements 112.

In some embodiments, the logic by which symmetric key program 101 selects particular secret data elements 112 stored on selected secret data servers 110a-n is based on an encryption policy 132 associated with the requesting entity. In some embodiments, the logic by which symmetric key program 101 selects particular secret data elements 112 stored on selected secret data servers 110a-n is included or indicated in the request. On the other hand, if no encryption policy associated with the requesting entity exists and no particular secret data elements 112 are indicated in the request, symmetric key program 101 automatically randomly selects one or more secret data elements 112 from those secret data servers 110a-n selected in step S210 for generation of a symmetric key for data encryption.

At step S212, symmetric key program 101 divides each secret data element 112 selected in step S210 into a plurality of secret data element byte strings. In some embodiments, secret data elements 112 are randomly divided into a number of byte strings of varying size. For example, a 128-bit secret data element is randomly divided as follows: 2-byte string, 1-byte string, 1-byte string, 4-byte string, 2-byte string, 2-byte string, 1-byte string, 1-byte string, and 2-byte string. In other embodiments, secret data elements 112 are divided into a predetermined number of byte strings of fixed size in accordance with an encryption policy 132 associated with the requesting entity. For example, an encryption policy 132 may include a rule to divide the same 128-bit secret data element into sixteen 1-byte strings, eight 2-byte strings, four 4-byte strings, etc.

At step S214, symmetric key program 101 stores the logic used to divide each secret data element 112 selected in step S212 as part of a decryption policy 134 for use by symmetric key program 101 to regenerate the symmetric key for data decryption.

At step S216, symmetric key program 101 combines particular secret data element byte strings from secret data elements 112 divided in step S212 to form a symmetric key for data encryption. In an embodiment, the symmetric key formed from the secret data elements byte strings is a 256-bit AES key. However, it should be noted that embodiments of present invention can be practiced to generate any size symmetric key for data encryption/decryption. For example, embodiments of the present invention can be practiced to generate a 128-bit AES key, a 192-bit AES key, or any generally known or future known AES keys greater than 256 bits.

In some embodiments, symmetric key program 101 generates the symmetric key by randomly combining a plurality of secret data element byte strings, such that the randomly combined plurality of secret data element byte strings have a predetermined total size (e.g., 256 bits). In other words, the combination of secret data element byte strings may be derived from any number of secret data elements 112 selected and divided in accordance with steps S210 and S212. Similarly, in some embodiments, the order in which secret data element byte strings are combined to generate the symmetric key is also random. In some embodiments, the combination of secret data element byte strings to generate the symmetric key is only partially random. Here, a user or system administrator may set particular standards or rules by which secret data element byte strings are randomly combined in an encryption policy 132. For example, a rule may define that the symmetric key must include at least one secret data element byte string randomly selected from each of the secret data elements selected and divided in accordance with steps 210 and 212.

In some embodiments, symmetric key program 101 combines particular secret data element byte strings to form the symmetric key based on an encryption policy 132 associated with the requesting entity. In some embodiments, symmetric key program 101 combines particular secret data element byte strings to form the symmetric key based on user input. For example, the particular secret data element bytes strings to be used to for the symmetric key is included or indicated in the request. On the other hand, if no encryption policy associated with the requesting entity exists and no particular secret data elements 112 are indicated in the request, symmetric key program 101 automatically randomly selects one or more secret data elements 112 from those secret data servers 110a-n selected in step S210 for generation of a symmetric key for data encryption.

At step S218, symmetric key program 101 stores the logic used to combine the particular secret data elements in step S216 as part of the decryption policy for use by symmetric key program 101 to regenerate the symmetric key for data decryption.

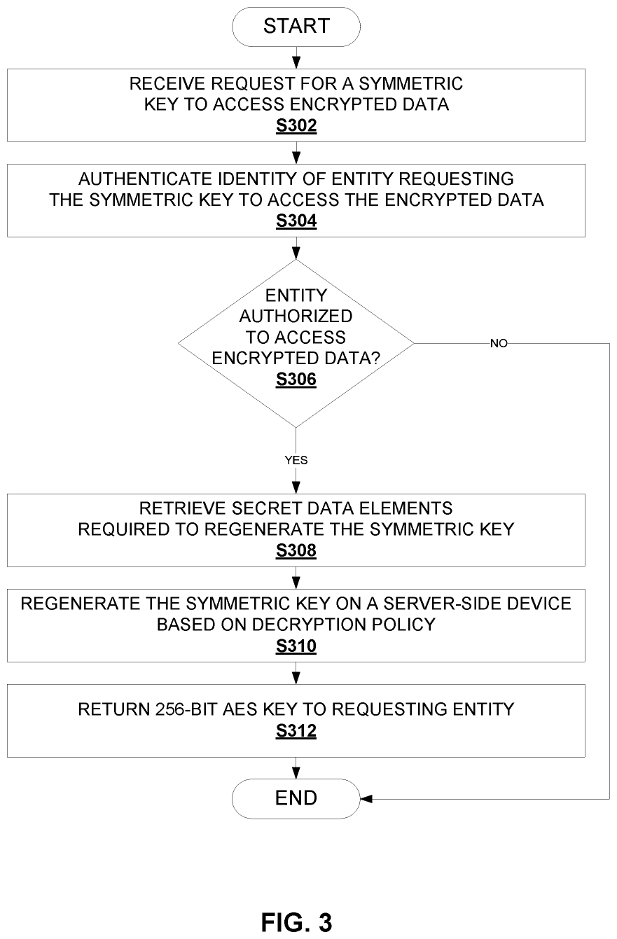

FIG. 3 is a flow chart diagram depicting operational steps for regenerating, on a server side device, a symmetric key for decrypting data in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

At step S302, symmetric key program 101 receives a request from client device 120 for a key to access encrypted data. In an embodiment, the request is generated by a user. In an embodiment, the request is generated by a device. In an embodiment, the request is generated by an application. In an embodiment the request is generated by a service.

At step S304, symmetric key program 101 authenticates an identity of the entity associated with the request for the key to access the encrypted data. For example, symmetric key program 101 authenticates a user identity based on the user providing a successful username and password combination. In another example, symmetric key program 101 authenticates an application based on the application providing a unique client ID and secret (the client ID and secret being used as the username and password) registered for the application. In yet another example, symmetric key program 101 authenticates a device based on the device providing a unique device ID and secret (the device ID and secret being used as the username and password) registered for the device.

At decision step S306, responsive to successfully authenticating the identity of an entity associated with the request for the key to access the encrypted data, symmetric key program 101 determines whether the entity is authorized to access the encrypted data. In an embodiment, symmetric key program 101 determines whether an entity is authorized to access encrypted data based on comparing an identity of the entity (e.g., user ID, client ID, device ID) to a set of permissions included in an ACL. In an embodiment, symmetric key program 101 determines whether an entity is authorized to access the encrypted data based on comparing a designated role of the entity (e.g., superuser administrator, general user, privileged user, customer) to permissions assigned to the particular role within an enterprise.

If the entity does not have authorization to access the encrypted data (decision step “NO” branch), symmetric key program 101 denies the request for the plurality of secret data elements and the process ends. If the entity is authorized to access the encrypted data (decision step “YES” branch), symmetric key program 101 proceeds to step S308.

At step S308, responsive to determining that the entity is authorized to access the encrypted data, symmetric key program 101 retrieves the particular secret data elements required to regenerate the symmetric key for data decryption. In an embodiment, symmetric key program 101 accesses a secret data element index that lists the particular secret data elements required to regenerate the symmetric key. For example, the secret data element index includes at least: (i) a first column that lists the secret data elements (and their respective Object IDs) required to generate the symmetric key and (ii) a second column that lists references that point to the unique network address where a particular secret data element can be located.

At step S310, symmetric key program 101 regenerates the symmetric key on a server-side device, such as key management server 140. Symmetric key program 101 regenerates the symmetric key based on accessing a decryption policy 134 associated with the symmetric key. In other words, symmetric key program 101 applies the logic included in the decryption policy 134 for dividing secret data elements into byte strings and combining particular secret data byte strings to regenerate the symmetric key. For example, symmetric key program 101 performs the following steps based on the logic included in a decryption policy associated with the symmetric key: (i) divides each of the secret data elements retrieved in Step S308 into a plurality of byte strings and (ii) combines particular byte strings from the plurality of byte strings to form a 256-bit AES key. In some embodiments, the decryption policy 134 is stored on key management server 140. In other embodiments, the decryption policy 134 is stored on a third party device accessible by symmetric key program 101, such as policy server 130.

One of ordinary skill in the art will appreciate that since the logic included in a decryption policy stems from the logic used to initially generate the symmetric key for data encryption, the logic included in the decryption policy for selecting, dividing, and combining particular secret data element byte strings to regenerate the symmetric key for data decryption is substantially similar to the logic used to select, divide, and combine particular secret data element byte strings to generate the symmetric key for data encryption. In other words, the logic included in a decryption policy used to regenerate a symmetric key for data decryption in accordance with FIG. 3 is the same logic used to initially generate the symmetric key for data encryption in accordance with steps S210, S212, and S216 in FIG. 2.

At step S312, symmetric key program 101 returns the symmetric key to the requesting entity. For example, symmetric key program 101 transmits the symmetric key from key management server 140 to client device 120.

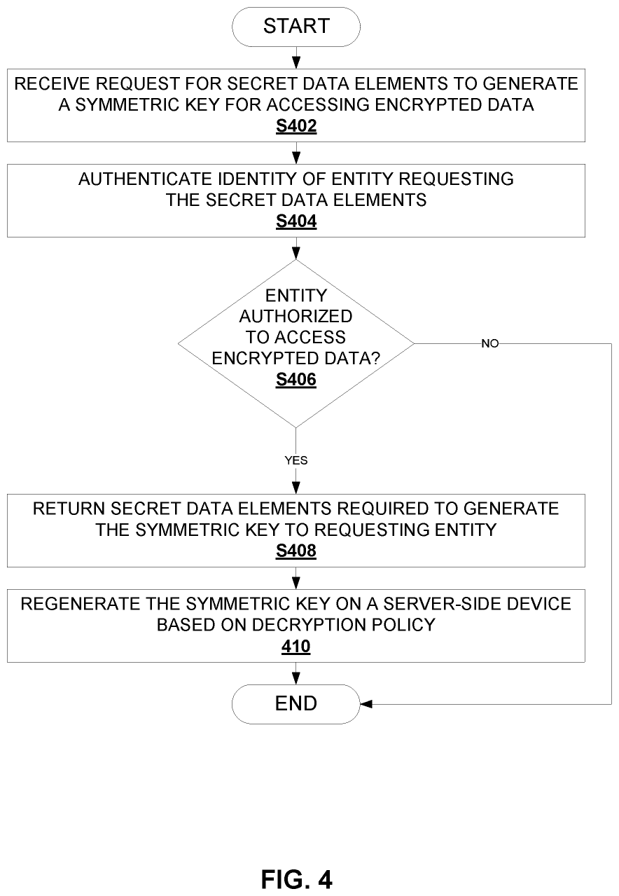

FIG. 4 is a flow chart diagram depicting operational steps for regenerating, on a client-side device, a symmetric key for decrypting data in accordance with at least one embodiment of the present invention. FIG. 4 provides only an illustration of one implementation and does not imply any limitations with regard to the environments in which different embodiments may be implemented. Many modifications to the depicted environment may be made by those skilled in the art without departing from the scope of the invention as recited by the claims.

At step S402, symmetric key program 101 receives a request from client device 120 for a set of secret data elements required for regenerating a symmetric key for access to encrypted data. In an embodiment, the request is generated by a user. In an embodiment, the request is generated by a device. In an embodiment, the request is generated by an application. In an embodiment the request is generated by a service.

At step S404, symmetric key program 101 authenticates an identity of the entity associated with the request for the set of secret data elements. Here, the authentication of an identity of entity can be performed in a manner substantially similar to that of step S304.

At decision step S406 responsive to successfully authenticating the identity of an entity associated with the request for the set of secret data elements, symmetric key program 101 determines whether the entity is authorized to access the encrypted data. Here, the determination as to whether the entity is authorized to access the encrypted data can be performed in a manner substantially similar to that of decision step S306. If the entity does not have authorization to access the encrypted data (decision step “NO” branch), symmetric key program 101 denies the request for the plurality of secret data elements and the process ends. If the entity is authorized to access the encrypted data (decision step “YES” branch), symmetric key program 101 proceeds to step S308.

At step S408, responsive to determining that the entity is authorized to access the encrypted data, symmetric key program 101 retrieves the secret data elements required to regenerate the symmetric key for data encryption. In an embodiment, symmetric key program 101 accesses a secret data element index that lists the particular secret data elements required to regenerate the 256-bit AES key. For example, the secret data element index includes at least: (i) a first column that lists the secret data elements (and their respective Object IDs) required to generate the symmetric key and (ii) a second column that lists references that point to the unique network address where a particular secret data element can be located.

At step S410, symmetric key program 101 regenerates the symmetric key on a client-side device associated with the requesting entity, such as client device 120. Symmetric key program 101 regenerates the symmetric key on client device 120 based on the decryption policy associated with the symmetric key. In other words, symmetric key program 101 uses the logic included in the decryption policy to divide secret data elements into byte strings and combine particular secret data byte strings to regenerate the symmetric key on client device 120. This is particularly advantageous in that the symmetric key need not be transmitted to client device 120 over a network, such as network 150. For example, symmetric key program 101 performs the following steps based on the logic included in a decryption policy associated with the symmetric key: (i) divides each of the secret data elements retrieved in Step S408 into a plurality of byte strings and (ii) combines particular byte strings from the plurality of byte strings to form a 256-bit AES key.

One of ordinary skill in the art will appreciate that since the logic included in a decryption policy stems from the logic used to initially generate the symmetric key for data encryption, the logic included in the decryption policy for selecting, dividing, and combining particular secret data element byte strings to regenerate the symmetric key for data decryption is substantially similar to the logic used to select, divide, and combine particular secret data element byte strings to generate the symmetric key for data encryption. In other words, the logic included in a decryption policy used to regenerate a symmetric key for data decryption in accordance with FIG. 4 is the same logic used to initially generate the symmetric key for data encryption in accordance with steps S210, S212, and S216 in FIG. 2.

In some embodiments, the decryption policy 134 is already stored on the client-side device. In other embodiments, the decryption policy is stored on server side device, such as key management server 140 or a third party device, such as a policy server 130. In those embodiments where the decryption policy 134 is stored on a third party device, such as policy server 130 symmetric key program 101 retrieves the logic from the decryption policy 134 required to regenerate a symmetric key from the set of secret data elements 112 returned to client device 120. This is particularly advantageous in that the secret data elements 112 used to form a symmetric key and the decryption policy 134 including the logic used to regenerate the symmetric key are never stored on the same device.

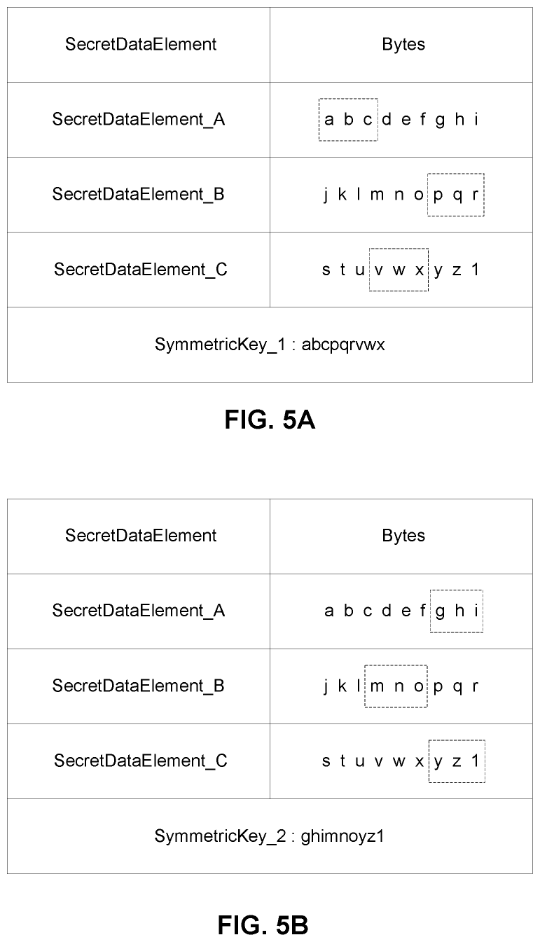

FIG. 5A is a block diagram that illustrates generating a first symmetric key from a set of secret data elements in accordance with at least one embodiment of the present invention. FIG. 5A includes SecretDataElement_A, SecretDataElement_B, and SecretDataElement_C, each of which may have been retrieved from a single secret data server 110a-n, three different secret data servers 110a-n, or any possible combination thereof. SecretDataElement_A includes bytes a, b, c, d, e, f, g, h, and i. SecretDataElement_B includes bytes j, k, l, m, n, o, p, q, and r. SecretDataElement_C includes bytes s, t, u, v, w, x, y, z, and l. As further depicted in FIG. 5A, a dotted line has been drawn around bytes “abc” of SecretDataElement_A, bytes “pqr” of SecretDataElement_B, and bytes “vwx” of SecretDataElement_C. Here, the dotted lines represent the respective byte strings selected from each of SecretDataElements A, B, and C for use in generating a symmetric key. Byte strings “abc,” “pqr,” and “vwx” are then combined to form SymmetricKey_1: “abcpqrvwx.” SymmetricKey_1 may further be assigned a UUID (e.g., SymmetricKey_1 is assigned UUID: KEY_132000aeb1cd000).

FIG. 5B is a block diagram that illustrates generating a second symmetric key from the same set of secret data elements of FIG. 5A in accordance with at least one embodiment of the present invention. As further depicted in FIG. 5B, a dotted line has been drawn around bytes “ghi” of SecretDataElement_A, bytes “mno” of SecretDataElement_B, and bytes “yzl” of SecretDataElement_C. Byte strings “ghi,” “mno,” and “yzl” are then combined to form SymmetricKey_2: “ghimnoyzl.” SymmetricKey_2 may further be assigned a UUID (e.g., SymmetricKey_2 is assigned UUID: Key_323000aeb1cd000).

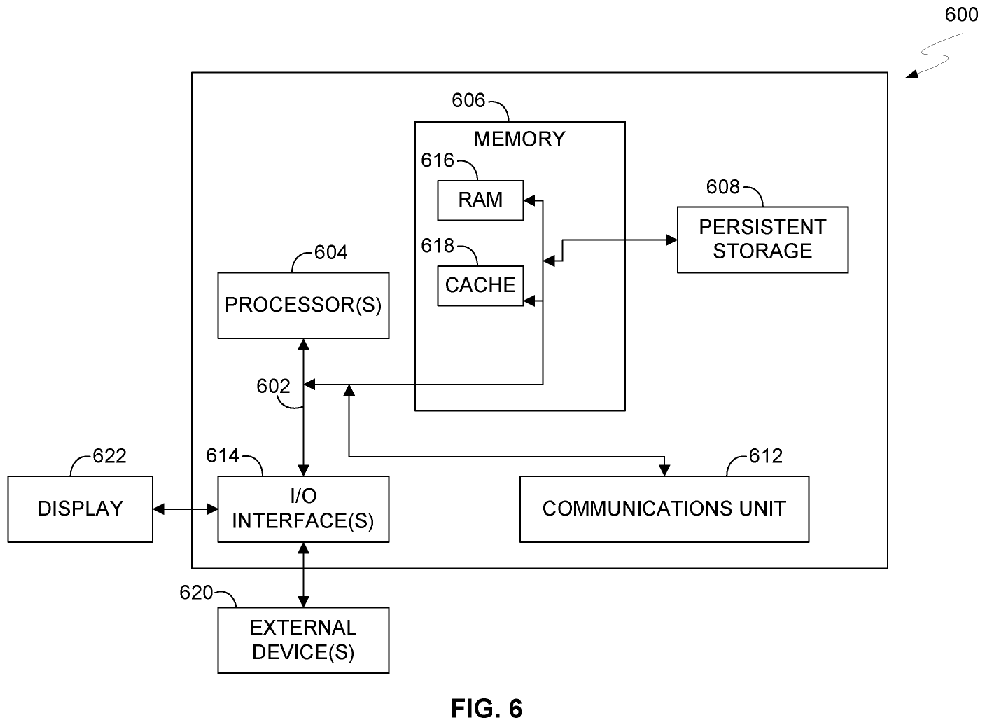

FIG. 6 is a block diagram depicting components of a computing device, generally designated 600, suitable for executing symmetric key program 101, client device 120, policy server 130, key management server 140, and/or any computing devices generally depicted in FIG. 1 in accordance with at least one embodiment of the present invention. Computing device 600 includes one or more processor(s) 604 (including one or more computer processors), communications fabric 602, memory 606 including, RAM 616 and cache 618, persistent storage 608, communications unit 612, I/O interface(s) 614, display 622, and external device(s) 620. It should be appreciated that FIG. 6 provides only an illustration of one embodiment and does not imply any limitations with regard to the environments in which different embodiments may be implemented. Many modifications to the depicted environment may be made.

As depicted, computing device 600 operates over communications fabric 602, which provides communications between computer processor(s) 604, memory 606, persistent storage 608, communications unit 612, and input/output (I/O) interface(s) 614. Communications fabric 602 can be implemented with any architecture suitable for passing data or control information between processor(s) 604 (e.g., microprocessors, communications processors, and network processors), memory 606, external device(s) 620, and any other hardware components within a system. For example, communications fabric 602 can be implemented with one or more buses.

Memory 606 and persistent storage 608 are computer readable storage media. In the depicted embodiment, memory 606 includes random-access memory (RAM) 616 and cache 618. In general, memory 606 can include any suitable volatile or non-volatile one or more computer readable storage media.

Program instructions for symmetric key program 101 can be stored in persistent storage 608, or more generally, any computer readable storage media, for execution by one or more of the respective computer processor(s) 604 via one or more memories of memory 606. Persistent storage 608 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 608 may also be removable. For example, a removable hard drive may be used for persistent storage 608. Other examples include optical and magnetic disks, thumb drives, and smart cards that are inserted into a drive for transfer onto another computer readable storage medium that is also part of persistent storage 608.

Communications unit 612, in these examples, provides for communications with other data processing systems or devices. In these examples, communications unit 612 can include one or more network interface cards. Communications unit 612 may provide communications through the use of either or both physical and wireless communications links. In the context of some embodiments of the present invention, the source of the various input data may be physically remote to computing device 600 such that the input data may be received, and the output similarly transmitted via communications unit 612.

I/O interface(s) 614 allows for input and output of data with other devices that may operate in conjunction with computing device 600. For example, I/O interface(s) 614 may provide a connection to external device(s) 620, which may be as a keyboard, keypad, a touch screen, or other suitable input devices. External device(s) 620 can also include portable computer readable storage media, for example thumb drives, portable optical or magnetic disks, and memory cards. Software and data used to practice embodiments of the present invention can be stored on such portable computer readable storage media and may be loaded onto persistent storage 608 via I/O interface(s) 614. I/O interface(s) 614 also can similarly connect to display 622. Display 622 provides a mechanism to display data to a user and may be, for example, a computer monitor.

What is claimed is:

1. A computer-implemented method for generating a symmetric key for data encryption, the computer-implemented method comprising:
receiving a first request from an entity to generate a first symmetric key for data encryption;
retrieving a first secret data element and a second secret data element from one or more secret data servers;
dividing each of the first secret data element and the second secret data element into a number of secret data element byte strings; and
generating the first symmetric key for data encryption based, at least in part, on combining a first secret data element byte string from the first secret data element and a second secret data element byte string from the second secret data element.

2. The computer-implemented method of claim 1, further comprising:
receiving a second request from the entity to generate a second symmetric key for data encryption;
retrieving the first secret data element and the second secret data element from the one or more secret data servers;
dividing each of the first secret data element and the second secret data element into the number of secret data element byte strings; and
generating a second symmetric key for data encryption based, at least in part, on combining a third secret data element byte string from the first secret data element and a fourth secret data element byte string from the second secret data element, wherein the third and fourth secret data element byte strings are distinct from the first and second secret data element byte strings.

3. The computer-implemented method of claim 1, further comprising:
generating a decryption policy for regenerating the symmetric key for data decryption, wherein the decryption policy includes:
a first rule for dividing the first secret data element and the second secret data element into the number of secret data element byte strings; and
a second rule for

4. The computer-implemented method of claim 1, wherein the one or more secret data servers are randomly selected.

5. The computer-implemented method of claim 1, wherein the one or more secret data servers are selected based on an encryption policy.

6. The computer-implemented method of claim 5, wherein the encryption policy includes at least one of:
a first rule that defines a predetermined threshold number of secret data servers from which to retrieve secret data;
a second rule that defines the particular secret data servers from which to retrieve secret data elements based on the particular data being encrypted; and
a third rule that defines the particular secret data servers from which to retrieve secret data elements based on a particular entity authorized to access the data encrypted by the symmetric key.

7. The computer-implemented method of claim 1, wherein the first secret data element is retrieved from a first secret data server and the second secret data element is retrieved from a second secret data server.

8. The computer-implemented method of claim 1, wherein the first secret data element and the second secret data element are randomly retrieved from the one or more secret data servers.

9. The computer-implemented method of claim 1, wherein the first secret data element and the second secret data element are retrieved from the one or more secret data servers based on an encryption policy.

10. The computer-implemented method of claim 9, wherein the encryption policy includes:
a first rule that defines the particular secret data elements to be retrieved from the one or more secret data servers;
a second rule that defines the particular secret data elements to be retrieved from the one or more secret data servers based on the particular data being encrypted; and
a third rule that defines the particular secret data elements to be retrieved from the one or more secret data servers based on a particular entity authorized to access the data encrypted by the symmetric key.

11. The computer-implemented method of claim 1, wherein each of the first secret data element byte string and the second secret data element byte string are respectively randomly selected from the first secret data element and the second secret data element.

12. The computer-implemented method of claim 1, wherein each of the first secret data element byte string and the second secret data element byte string are respectively selected from the first secret data element and the second secret data element based on an encryption policy.

13. The computer-implemented method of claim 1, wherein combining the first secret data element byte string and the second secret data element byte string further includes randomly selecting the first secret data element byte string from the first secret data element and the second secret data element byte from the second secret data element.

14. The computer-implemented method of claim 1, wherein combining the first secret data element byte string and the second secret data element byte string further includes selecting the first secret data element byte string from the first secret data element and the second secret data element byte from the second secret data element based on an encryption policy.

15. The computer-implemented method of claim 1, wherein an order in which the first secret data element byte string and the second secret data element byte string are combined to generate the symmetric key is random.

16. The computer-implemented method of claim 1, wherein an order in which the first secret data element byte string and the second secret data element byte string are combined to generate the symmetric key is based on an encryption policy.

17. The computer-implemented method of claim 1, wherein the symmetric key is a 256-bit advanced encryption standard (AES) key.

18. A computer-implemented method for regenerating a symmetric key for data decryption, the computer-implemented method comprising:
receiving, by a server-side device, a request for a plurality of secret data elements for regenerating a symmetric key for access to encrypted data;
retrieving, by the server-side device, a first secret data element and a second secret data element from a first secret data server;
transmitting, by the server-side device, the first secret data element and the second secret data element to the client-side device; and
regenerating, by the client-side device, the symmetric key based on a decryption policy, wherein the decryption policy includes:
a first rule for dividing each of the first secret data element and the secret data element into a number of secret data element byte strings;
a second rule for selecting a first secret data element byte string from the first secret data element and a second secret data element byte string from the second secret data element; and
a third rule for combining the first secret data element byte string and the second secret data element byte string to form the symmetric key.

19. The computer-implemented method of claim 18, further comprising:
retrieving, by the server-side device, the decryption policy for regenerating the symmetric key for data decryption; and
transmitting, by the server-side device, the first secret data element and the second secret data element to the client-side device.

20. A computer-implemented method for regenerating a symmetric key for data decryption, the computer-implemented method comprising:
receiving, by a server-side device, a request from a client-side device for a symmetric key to access encrypted data;
retrieving, by the server-side device, a first secret data element and a second secret data element from a first secret data server;
regenerating, by the server-side device, the symmetric key based on a decryption policy, wherein the decryption policy includes:
a first rule for dividing each of the first secret data element and the secret data element into a number of secret data element byte strings;
a second rule for selecting a first secret data element byte string from the first secret data element and a second secret data element byte string from the second secret data element; and
a third rule for combining the first secret data element byte string and the second secret data element byte string to form the symmetric key; and
transmitting, by the server-side device, the symmetric key to the client-side device.
